(19) United States
(12) Patent Application Publication
(10) Pub. No.: US 2013/0120972 A1
(43) Pub. Date: May 16, 2013

(54) Pendent lamp having an air conditioning function

(71) Applicants: Chen-Yu Chung, Taichung City (TW); Sheng-Chi Chung, Taichung City (TW)

(72) Inventors: Chen-Yu Chung, Taichung City (TW); Sheng-Chi Chung, Taichung City (TW)

(21) Appl. No.: 13/296,295

(22) Filed: Nov. 15, 2011

(51) Int. Cl. F21V 29/00; F21S 8/04

(52) U.S. Cl. 362/147

(57) ABSTRACT

A pendent lamp includes a support member mounted on a ceiling, an air conditioning unit mounted on the support member, an outer hood connected with the air conditioning unit, a decorative member connected with the outer hood, at least one air outlet port formed between the outer hood and the decorative member, and a lighting unit mounted on the support member. Thus, the air conditioning unit supplies cold air or hot air to the house to decrease or increase the temperature in the house to provide a cooling or warming effect to the house so as to regulate the temperature of the house at the optimum value.

### BACKGROUND OF THE INVENTION

1. Field of the Invention

The present invention relates to a lamp and, more particularly, to a pendent lamp mounted in a house.

2. Description of the Related Art

A conventional pendent lamp in accordance with the prior art shown in FIG. 1 is mounted in a house and comprises a fan device “B” and a lighting device “A”. In operation, the fan device “B” is operated successively to produce an air flow to provide a ventilating and heat dissipation effect to the house so as to lower the temperature in the house. However, the blades of the fan device “B” easily produce noise during operation, thereby greatly causing an uncomfortable sensation to the people in the house.

### BRIEF SUMMARY OF THE INVENTION

In accordance with one embodiment of the present invention, there is provided a pendent lamp, comprising a support member mounted on a ceiling, an air conditioning unit mounted on the support member, an outer hood connected with the air conditioning unit, a decorative member connected with the outer hood, at least one air outlet port formed between the outer hood and the decorative member, and a lighting unit mounted on the support member.

In accordance with another embodiment of the present invention, there is provided a pendent lamp, comprising a support member mounted on a ceiling, an air conditioning unit mounted on the support member, an outer hood connected with the air conditioning unit, an air outlet member connected with the outer hood, and a lighting unit mounted on the support member.

The primary objective of the present invention is to provide a pendent lamp having an air conditioning function.

According to the primary advantage of the present invention, the air conditioning unit supplies cold air or hot air to the house to decrease or increase the temperature in the house to provide a cooling or warming effect to the house so as to regulate the temperature of the house at the optimum value.

According to another advantage of the present invention, the air conditioning unit does not have fan blades so that the air conditioning unit will not produce noise and will not decrease the lighting effect of the lighting unit.

According to a further advantage of the present invention, the pendent lamp has a simplified construction and is operated easily and conveniently.

According to a further advantage of the present invention, the air conditioning unit will not produce noise during operation, thereby greatly causing a comfortable sensation to the people in the house.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a front view of a conventional pendent lamp in accordance with the prior art.

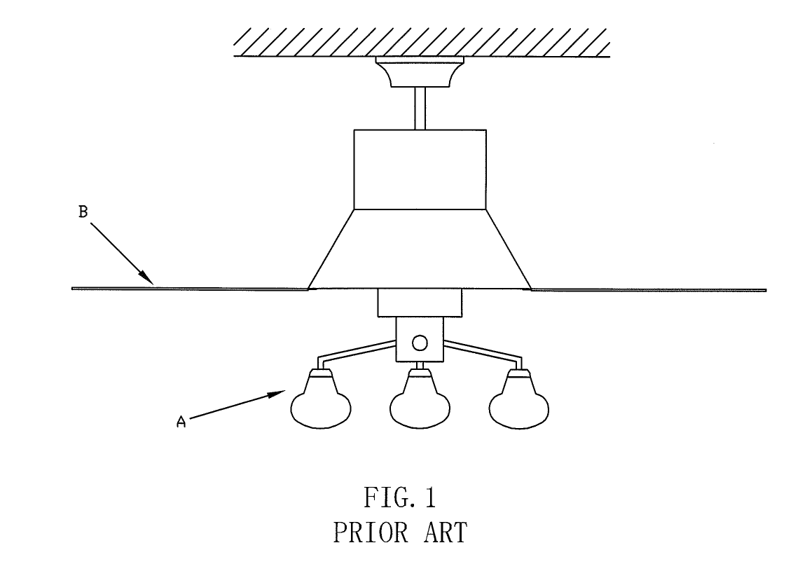

FIG. 2 is a front cross-sectional view of a pendent lamp in accordance with the first preferred embodiment of the present invention.

FIG. 3 is a front cross-sectional view of a pendent lamp in accordance with the second preferred embodiment of the present invention.

FIG. 4 is a partially exploded view of the pendent lamp as shown in FIG. 3.

FIG. 5 is a front cross-sectional view of a pendent lamp in accordance with another preferred embodiment of the present invention.

### DETAILED DESCRIPTION OF THE INVENTION

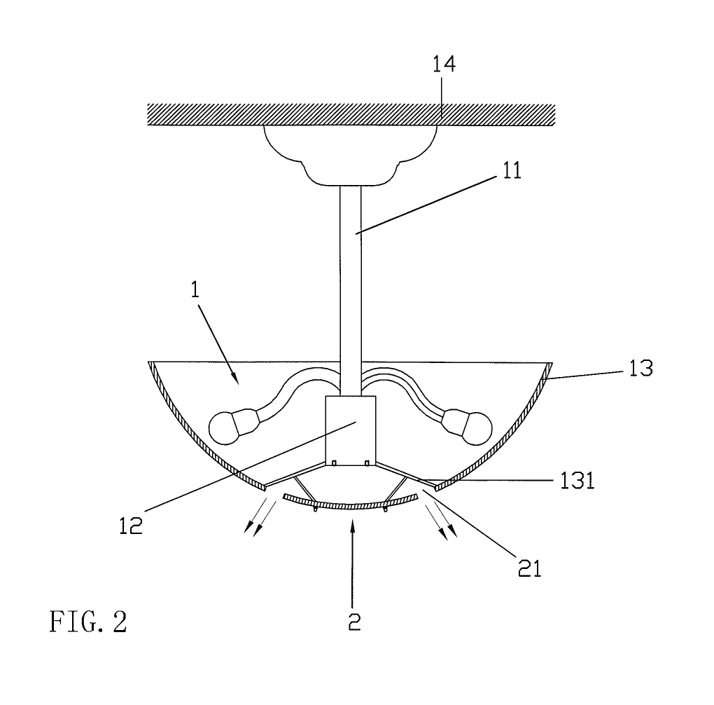

Referring to the drawings and initially to FIG. 2, a pendent lamp in accordance with the first preferred embodiment of the present invention comprises a support member 11 mounted on a ceiling 14, an air conditioning unit 12 mounted on the support member 11, an outer hood 13 connected with the air conditioning unit 12, a decorative member 2 connected with the outer hood 13, at least one air outlet port 21 formed between the outer hood 13 and the decorative member 2, and a lighting unit 1 mounted on the support member 11.

The lighting unit 1 is located between the support member 11 and the air conditioning unit 12 and is surrounded by the outer hood 13. The air conditioning unit 12 is located between the lighting unit 1 and the decorative member 2 and is surrounded by the outer hood 13. The outer hood 13 has an inner side provided with at least one air guide member 131. The air guide member 131 of the outer hood 13 is connected with the air conditioning unit 12 and is located between the air conditioning unit 12 and the air outlet port 21. The decorative member 2 is located at an open bottom of the outer hood 13 and is connected with the air guide member 131 of the outer hood 13. The decorative member 2 is located under the air conditioning unit 12. The air outlet port 21 is connected to the air conditioning unit 12 through the air guide member 131 of the outer hood 13.

In operation, the air conditioning unit 12 blows air through the air outlet port 21 defined between the outer hood 13 and the decorative member 2 so that the air is delivered outward from the air outlet port 21 into the house so as to provide an air conditioning and heat dissipation function to the house and to reduce the temperature in the house. At this time, the air flow are directed and guided by the air guide member 131 of the outer hood 13 so that the air is diffused outward from the air outlet port 21 and is distributed in the house evenly and smoothly.

In the preferred embodiment of the present invention, the air conditioning unit 12 includes an air blower and a motor connected with the air blower to drive the air blower. Thus, the air blower is driven by the motor to blow air outward so as to dissipate the heat and to lower down the temperature in the house.

Alternatively, the air conditioning unit 12 includes an air blower and a turbine connected with the air blower to drive the air blower. Thus, the air blower is driven by the turbine to blow air outward so as to dissipate the heat and to lower down the temperature in the house.

Alternatively, the air conditioning unit 12 includes an air condenser to deliver cold air outward so as to dissipate the heat and to lower down the temperature in the house.

Alternatively, the air conditioning unit 12 includes an air heater to deliver hot air outward so as to increase the temperature in the house.

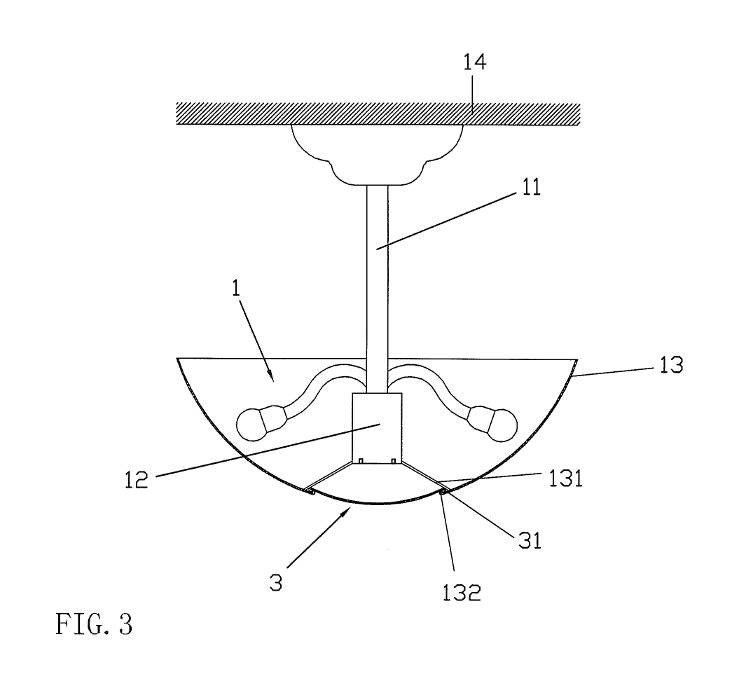

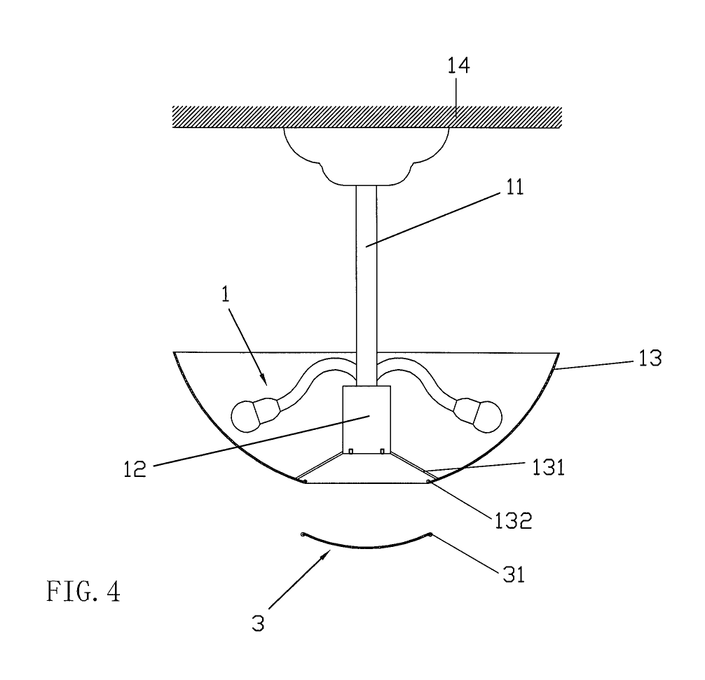

Referring to FIGS. 3 and 4, a pendent lamp in accordance with the second preferred embodiment of the present invention comprises a support member 11 mounted on a ceiling 14, an air conditioning unit 12 mounted on the support member 11, an outer hood 13 connected with the air conditioning unit 12, an air outlet member 3 connected with the outer hood 13, and a lighting unit 1 mounted on the support member 11.

The lighting unit 1 is located between the support member 11 and the air conditioning unit 12 and is surrounded by the outer hood 13. The air conditioning unit 12 is located between the lighting unit 1 and the air outlet member 3 and is surrounded by the outer hood 13. The outer hood 13 has an inner side provided with at least one air guide member 131. The air guide member 131 of the outer hood 13 is connected with the air conditioning unit 12 and is located between the air conditioning unit 12 and the air outlet member 3. The outer hood 13 has an open bottom provided with a first connecting portion 132. Preferably, the first connecting portion 132 of the outer hood 13 has an annular shape. The air outlet member 3 has a net-shaped profile. The air outlet member 3 is located at the open bottom of the outer hood 13 and is located under the air conditioning unit 12. The air outlet member 3 has a periphery provided with a second connecting portion 31 connected with the first connecting portion 132 of the outer hood 13. Preferably, the second connecting portion 31 of the air outlet member 3 has a bent shape.

In operation, the air conditioning unit 12 blows air through the air outlet member 3 so that the air is delivered outward from the air outlet member 3 into the house so as to provide an air conditioning and heat dissipation function to the house and to reduce the temperature in the house. At this time, the air flow are directed and guided by the air guide member 131 of the outer hood 13 so that the air is diffused outward from the air outlet member 3 and is distributed in the house evenly and smoothly.

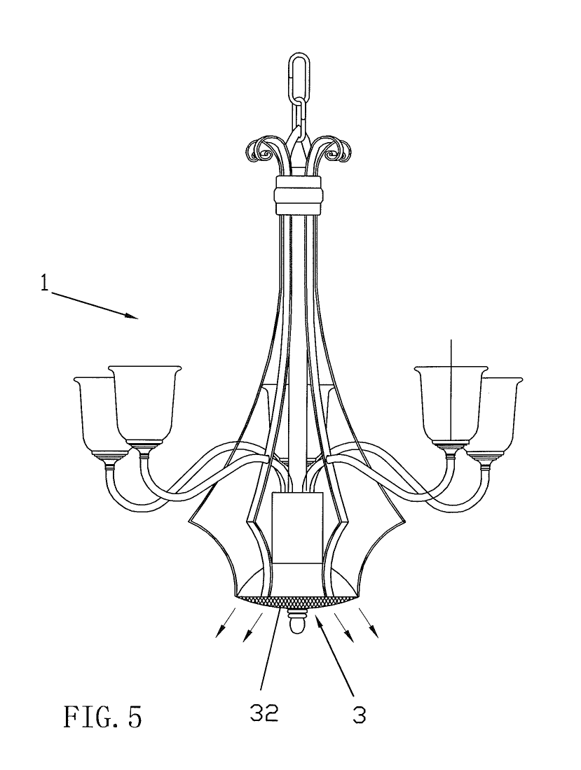

Referring to FIG. 5, the air outlet member 3 has a surface provided with a plurality of ventilating holes 32. Each of the ventilating holes 32 of the air outlet member 3 has a substantially diamond shape.

Accordingly, the air conditioning unit 12 supplies cold air or hot air to the house to decrease or increase the temperature in the house to provide a cooling or warming effect to the house so as to regulate the temperature of the house at the optimum value. In addition, the air conditioning unit 12 does not have fan blades so that the air conditioning unit 12 will not produce noise and will not decrease the lighting effect of the lighting unit 1. Further, the pendent lamp has a simplified construction and is operated easily and conveniently. Further, the air conditioning unit 12 will not produce noise during operation, thereby greatly causing a comfortable sensation to the people in the house.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A pendent lamp, comprising:
a support member mounted on a ceiling;
an air conditioning unit mounted on the support member;
an outer hood connected with the air conditioning unit;
a decorative member connected with the outer hood;
at least one air outlet port formed between the outer hood and the decorative member; and
a lighting unit mounted on the support member.

2. The pendent lamp of claim 1, wherein the outer hood has an inner side provided with at least one air guide member.

3. The pendent lamp of claim 2, wherein the air guide member of the outer hood is connected with the air conditioning unit.

4. The pendent lamp of claim 2, wherein the air guide member of the outer hood is located between the air conditioning unit and the air outlet port.

5. The pendent lamp of claim 2, wherein the decorative member is connected with the air guide member of the outer hood.

6. The pendent lamp of claim 2, wherein the air outlet port is connected to the air conditioning unit through the air guide member of the outer hood.

7. The pendent lamp of claim 1, wherein
the lighting unit is located between the support member and the air conditioning unit;
the lighting unit is surrounded by the outer hood;
the air conditioning unit is located between the lighting unit and the decorative member;
the air conditioning unit is surrounded by the outer hood;
the decorative member is located at an open bottom of the outer hood;
the decorative member is located under the air conditioning unit.

8. The pendent lamp of claim 1, wherein the air conditioning unit includes an air blower and a motor connected with the air blower to drive the air blower.

9. The pendent lamp of claim 1, wherein the air conditioning unit includes an air blower and a turbine connected with the air blower to drive the air blower.

10. The pendent lamp of claim 1, wherein the air conditioning unit includes an air condenser to deliver cold air outward or an air heater to deliver hot air outward.

11. A pendent lamp, comprising:
a support member mounted on a ceiling;
an air conditioning unit mounted on the support member;
an outer hood connected with the air conditioning unit;
an air outlet member connected with the outer hood; and
a lighting unit mounted on the support member.

12. The pendent lamp of claim 11, wherein the outer hood has an inner side provided with at least one air guide member.

13. The pendent lamp of claim 12, wherein the air guide member of the outer hood is connected with the air conditioning unit.

14. The pendent lamp of claim 12, wherein the air guide member of the outer hood is located between the air conditioning unit and the air outlet member.

15. The pendent lamp of claim 11, wherein
the outer hood has an open bottom provided with a first connecting portion;
the air outlet member has a periphery provided with a second connecting portion connected with the first connecting portion of the outer hood.

16. The pendent lamp of claim 15, wherein
the first connecting portion of the outer hood has an annular shape;
the second connecting portion of the air outlet member has a bent shape.

17. The pendent lamp of claim 11, wherein the air outlet member has a net-shaped profile.

18. The pendent lamp of claim 11, wherein the air outlet member has a surface provided with a plurality of ventilating holes.

19. The pendent lamp of claim 18, wherein each of the ventilating holes of the air outlet member has a substantially diamond shape.

20. The pendent lamp of claim 15, wherein
the lighting unit is located between the support member and the air conditioning unit;
the lighting unit is surrounded by the outer hood;
the air conditioning unit is located between the lighting unit and the air outlet member;
the air conditioning unit is surrounded by the outer hood;
the air outlet member is located at the open bottom of the outer hood;
the air outlet member is located under the air conditioning unit.
